(19) United States
(12) Patent Application Publication
(10) Pub. No.: US 2020/0354000 A1
(43) Pub. Date: Nov. 12, 2020

(54) ELECTRIC VEHICLE

(71) Applicant: Dyson Automotive Research and Development Limited, Chippenham (GB)

(72) Inventor: Peter David GAMMACK, Gloucester (GB)

(73) Assignee: Dyson Automotive Research and Development Limited, Chippenham (GB)

(21) Appl. No.: 16/760,386

(22) PCT Filed: Oct. 29, 2018
(86) PCT No.: PCT/GB2018/053123

§ 371 Date: Apr. 29, 2020

(30) Foreign Application Priority Data
Oct. 31, 2017 (GB) 1717884.9

(51) Int. Cl. B62D 35/02; B60K 1/04; B60J 1/02

(52) U.S. Cl. CPC B62D 35/02; B60K 2001/0438; B60J 1/02; B60K 1/04

(57) ABSTRACT

Provided are electric vehicles having a relatively short height (between 1600 mm and 1800 mm), a relatively high ground clearance (at least 260 mm), and a windscreen inclined at a relatively shallow angle (between 25 and 30 degrees relative to the horizontal plane), wherein the horizontal distance between a leading edge of the vehicle and a leading edge of the windscreen is less than 870 mm.

### REFERENCE TO RELATED APPLICATIONS

This application is a national stage application under 35 USC 371 of International Application No. PCT/GB2018/053123, filed Oct. 29, 2018, which claims the priority of United Kingdom Application No. 1717884.9, filed Oct. 31, 2017, the entire contents of each of which are incorporated herein by reference.

### FIELD OF THE DISCLOSURE

The disclosure relates to an electric vehicle having attributes that improve energy efficiency in order to increase driving range.

### BACKGROUND OF THE DISCLOSURE

The electric vehicle segment is experiencing rapid technological development. Most major car manufacturers either offer an electric vehicle for sale or have one in development. With the gradual but inevitable decline of fossil fuels, this upwards trend in the technological sophistication and availability of electric vehicles is set to continue.

Current battery technology provides limited energy density compared to liquid fuels such as gasoline and diesel. It is therefore important that the energy is used prudently in order to maximise the driving range of the electric vehicle.

Currently, manufacturers tend to base their electric vehicles on existing models but adapt them appropriately with suitable electric propulsion systems. Such an approach tends to be cost effective because it avoids the need for ground-up design to optimise the vehicle for electrification. However, this approach tends to miss opportunities for mass reduction and aerodynamic improvements which would improve the energy efficiency of the vehicle. Another approach apparent in the market is to focus on smaller vehicles as this generally keeps the mass of the vehicle low which improves the opportunity to extend the driving range. However, the size and ride comfort of such vehicles tends to limit their attractiveness to the buying public.

### SUMMARY OF THE DISCLOSURE

Embodiments of the present disclosure provide an electric vehicle having a vehicle height of between 1600 mm and 1800 mm, a ground clearance of at least 260 mm, and a windscreen inclined at an angle of between 25 and 30 degrees relative to the horizontal plane, wherein the horizontal distance between a leading edge of the vehicle and a leading edge of the windscreen is less than 870 mm.

The vehicle therefore has a relatively high ground clearance, which has at least two benefits. First, the vehicle is better suited to travel over rough terrain. Second, the driver has a higher seating position, which promotes better visibility and safety. Existing vehicles having a high ground clearance also have a high vehicle height. By contrast, the vehicle of the present disclosure has a vehicle height of between 1600 mm and 1800 mm. This comparatively lower vehicle height has at least two advantages. First, a lower centre of gravity is achievable, which promotes better handling. Second, and perhaps more importantly, the lower vehicle height reduces the frontal area of the vehicle. Indeed, the vehicle may have a frontal area less than 2.7 square metres. As a result, the drag of the vehicle is reduced and driving range is increased.

There is an existing prejudice that, in order to reduce the drag coefficient of a vehicle, the vehicle should be designed such that the bulk of the air is forced over the top of the vehicle. Accordingly, when looking to improve the driving range, engineers will typically design a vehicle having a low ground clearance. The engineers responsible for the vehicle of the present disclosure have found that, contrary to current thinking, a relatively high ground clearance can be used without significantly impacting the drag coefficient.

The windscreen is inclined at a relatively shallow angle, i.e. between 25 and 30 degrees relative to the horizontal plane. This has the benefit of reducing the aerodynamic drag coefficient of the vehicle. However, as the inclination angle decreases, the seating position of the driver is pushed further rearward. As a result, the driver may have greater difficulty in estimating the front extremity of the vehicle, which then has implications for parking and low speed maneuvering. With the vehicle of the present disclosure, the front section of the vehicle is relatively short. In particular, the horizontal distance between the leading edge (i.e. the front) of the vehicle and the leading edge of the windscreen is less than 870 mm. As a result, the efficiency and thus the driving range of the vehicle are improved, courtesy of the shallow windscreen angle, without adversely impacting the driver's ability to gauge the front extremity of the vehicle.

The vehicle may comprise a driver seat having a seat height (i.e. the vertical distance between the H-point and the cabin floor) of between 260 mm and 300 mm. The driver therefore has a reclined seating position typical of a saloon or sedan vehicle. By contrast, conventional vehicles having a high seating position typically have a much taller seat height such that the driver adopts a more upright seating position. However, an upright seating position demands a taller passenger cabin. By having a relatively low seat height, the height of the cabin can be reduced. As a result, it is possible to achieve a vehicle having a low frontal area (i.e. vehicle height of between 1600 mm and 1800 mm, and a ground clearance greater than 260 mm) whilst also providing sufficient head room.

The vertical distance between the driver H-point and the ground may be at least 740 mm. The vehicle therefore has a relatively high seating position, which, as noted above, promotes better visibility and safety.

If the vehicle has a relatively low seat height, the horizontal distance between the front wheel axis and the driver H-point will increase. As a consequence, the driver is located further from the front of the vehicle. In order to compensate for this, the vehicle may have a relatively short front overhang. In particular, the vehicle may have a front overhang less than 850 mm Consequently, in spite of the low seat height, the distance between the driver and the front of the vehicle need not be excessive. The driver is then better able to gauge the front extremity of the vehicle, which in turn eases parking and low-speed maneuvering.

The vehicle has a vehicle height of between 1600 mm and 1800 mm, and a ground clearance greater than 260 mm Whilst this has the advantage of reducing the frontal area of the vehicle, it has the adverse consequence of reducing the height of the passenger cabin. In order to compensate for this, the vehicle may have a relatively long wheelbase. In particular, the wheelbase may be between 3200 mm and 3350 mm. As a result, a vehicle having a relatively large cabin capacity may be achieved. As well as achieving a large cabin capacity, a long wheelbase has at least two other advantages. First, a longer wheelbase generally provides for a more comfortable ride. Second, where the battery pack of the vehicle is positioned beneath the cabin, a longer wheelbase enables a larger battery pack to be employed, which then increases the driving range.

The vehicle may have a vehicle length of between 4700 mm and 5000 mm Consequently, in spite of the long wheelbase, the length of the vehicle is not excessive, which aids in parking and low speed maneuvering. The length of the vehicle relative to the wheelbase also results in relatively short overhangs. This then has the benefit of producing larger approach and departures angles. As a result, the vehicle is better suited at handling steep terrain and obstacles.

In spite of the relatively long wheelbase, the high ground clearance makes it possible to achieve a relatively high breakover angle. In particular, a breakover angle of at least 20 degrees is possible. As a result, the vehicle continues to be well suited to travel over rough terrain in spite of the long wheelbase.

The vehicle may comprise a battery pack positioned beneath the cabin of the vehicle. Locating the battery pack beneath the cabin has the benefit of lowering the centre of gravity of the vehicle, which helps promote better handling. Additionally, the space beneath the cabin provides useful real estate. Accordingly, where the wheelbase of the vehicle is relatively long, a relatively large battery pack may be employed. However, locating the battery pack beneath the cabin is not without its difficulties. In particular, the battery pack is vulnerable to ground impact or intrusion. Nevertheless, with the vehicle of the present disclosure, the relatively high ground clearance significantly reduces this risk.

The vehicle may have a front overhang less than 850 mm and a rear overhang less than 950 mm. The overhangs are therefore relatively short, making it easier to park and maneuver the vehicle at low speed. Shorter overhangs have the further benefit of producing larger approach and departures angles. As a result, the vehicle is better suited at handling steep terrain and obstacles. When combined with the claimed ground clearance, the vehicle may have an approach angle and a departure angle of at least 25 degrees.

The vehicle has a vehicle height of between 1600 mm and 1800 mm and a ground clearance of at least 260 mm More particularly, the vertical distance between the roof of the vehicle and the underside of the vehicle may be between 1340 mm and 1465 mm. This then provides a good balance between the need to reduce the frontal area whilst providing sufficient cabin height.

The vehicle may comprise wheels having an outer diameter of between 45% and 55% of the vehicle height. The wheels of the vehicle are therefore relatively large as a percentage of the vehicle height. Wheels of this size have the benefit of significantly reducing the rolling resistance of the vehicle. As a result, an increase in the driving range may be achieved. The size of the wheels also makes possible the relatively high ground clearance, which in turn enables a high seating position. A high ground clearance and high seating position may alternatively be achieved using smaller wheels and a raised suspension. However, this then compromises the handling of the vehicle, and the resulting driveshaft angle will lead to increased joint wear and vibration. By employing relatively large wheels, a relatively high seating position may be achieved whilst also promoting good handling. Additionally, a relatively high ground clearance may be achieved with a shallow driveshaft angle.

There are a number of prejudices that would deter an engineer from employing wheels of this size. First, larger wheels have a greater moment of inertia and therefore require more energy to accelerate and decelerate. There is therefore an existing prejudice that larger wheels are less efficient and will decrease the driving range of a vehicle. Second, there is an existing prejudice that wheels of this size would worsen ride comfort due to the larger unsprung mass. Third, larger wheels require a larger space envelope. In particular, as the size of the front wheels increases, deeper wheel arches are required in order to accommodate the wheels during turning. For a conventional vehicle having an internal combustion engine (ICE), deeper wheel arches are possible only by increasing the vehicle width; this is because it is not normally possible to reduce the size of the engine bay or the location of the front longitudinal members. Manufacturers of ICE vehicles looking to produce an electric vehicle would continue to use the body of the ICE vehicle owing to the huge expense associated with redesigning the body. When designing an electric vehicle, engineers would not think to use wheels of the size presently claimed. The engineers would understand that to do so would require a significant increase in the vehicle width or a fundamental redesign of the body. Any increase in the vehicle width will increase the frontal area of the vehicle and thus decrease the driving range, whereas a fundamental redesign of the body would be hugely expensive without any perceived benefit.

With the electric vehicle of the present disclosure, the engineers had to overcome many existing prejudices. In doing so, the engineers discovered that the provision of large wheels can bring about significant and often surprising technical benefits. In particular, the engineers identified that, for an electric vehicle, energy may be recovered during braking which can help mitigate the higher inertia associated with larger wheels. Moreover, the engineers observed that the decrease in the rolling resistance that is achieved at this wheel size can offset the increase in inertia such that a net gain in the driving range may be achieved. The engineers also recognised that, by employing larger wheels, a given load index can be achieved for a lower tire pressure. By reducing the tire pressure, a more comfortable ride may be achieved. The engineers further recognised that wheels of this size can be employed without unduly increasing the vehicle width. In particular, the engineers recognised that the size of the front bay of the vehicle, which is conventionally occupied by an engine, may be reduced by locating elements of the powertrain elsewhere, e.g. by locating the battery pack on the underside of the vehicle. As a result, the vehicle body may be designed with a narrower front bay such that deeper wheel arches may be achieved for the same vehicle width. Consequently, it is possible to employ wheels of the size presently claimed in an electric vehicle without unduly increase the vehicle width and thus the frontal area of the vehicle.

The wheels may have a section width of between 27% and 32% of the outer diameter of the wheels. Consequently, the wheels are relatively narrow. A narrower wheel has the advantage of reducing the mass and frontal area of the vehicle, thereby increasing the efficiency and driving range. However, as the width of the wheel decreases, the load index decreases. An electric vehicle is typically heavier than an equivalent ICE vehicle owing to the mass of the battery pack. As a result, wheels having a higher load index are required. The engineers responsible for designing the vehicle of the present disclosure were advised by tire manufactures that wheels at these dimensions would fail to provide a sufficient load index. However, the engineers found that, by employing a section width of between 27% and 32% of the outer diameter, sufficient load index may be achieved whilst also providing a significant reduction in mass and frontal area. More particularly, the engineers found that a relatively good balance in the competing factors (e.g. rolling resistance, inertia and load index) may be achieved by employing wheels having an outer diameter of between 800 mm and 850 mm, and a section width of between 235 mm and 255 mm.

The wheels may have a section height of between 80 mm and 135 mm. For a wheel having a given rim diameter, the rolling resistance decreases as the section height increases. Additionally, as the section height increases, a lower tire pressure may be used to achieve a given load index, which then improves ride comfort. However, as the section height increases, the inertia of the wheel increases. A section height of between 80 mm and 135 mm has been found to provide a good balance between the competing factors of efficiency, comfort and load index.

As noted above, the engineers responsible for the present disclosure recognised that the width of the front bay of the vehicle may be reduced by locating elements of the powertrain elsewhere. As a result, it is possible to employ large wheels without unduly increasing the vehicle width and thus the frontal area of the vehicle. Indeed, the vehicle width may be less than 1975 mm. This is then comparable to some SUVs, and is significantly less than other SUVs for which the vehicle width is greater than 2000 mm. The technical benefits associated with having large wheels can therefore be achieved in an electric vehicle with a vehicle width comparable to that of existing SUVs.

Within the scope of this application it is expressly intended that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are clearly incompatible.

### BRIEF DESCRIPTION OF THE FIGURES

In order that the invention may be more readily understood, reference will now be made by way of example only to the accompanying drawings in which:

FIG. 1 is a side view of a vehicle, according to some embodiments;

FIG. 2a is a front view of the vehicle in FIG. 1, whereas FIG. 2b is a depiction of the vehicle frontal area, according to some embodiments;

FIG. 3 is a cross-section through one of the wheels of the vehicle in FIGS. 1 and 2, taken along the vertical plane of the wheel, according to some embodiments; and

FIG. 4 is side view of the vehicle, like that in FIG. 1, but which shows the body proportions of the vehicle in terms of wheel diameters, according to some embodiments.

### DETAILED DESCRIPTION OF THE DISCLOSURE

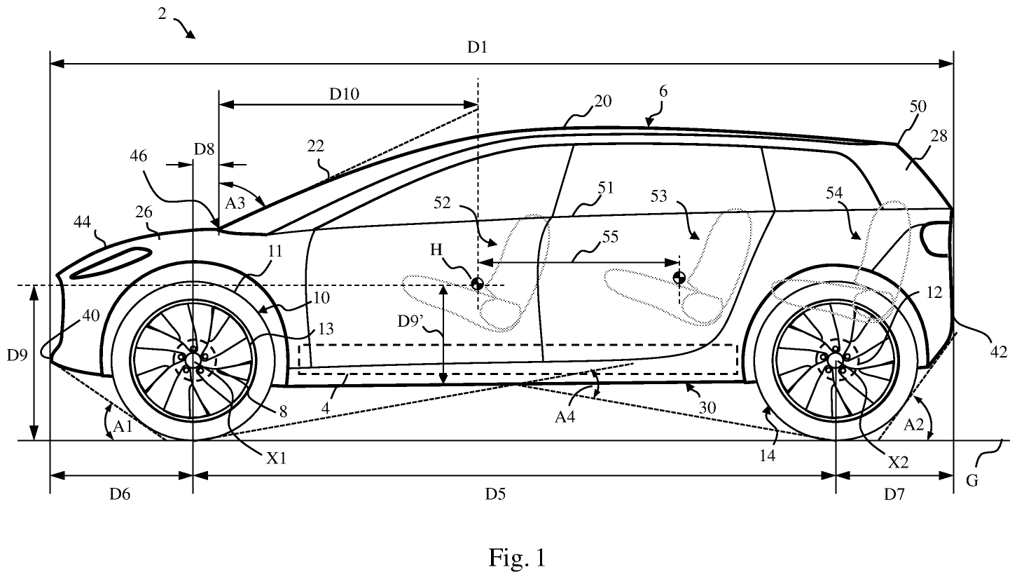

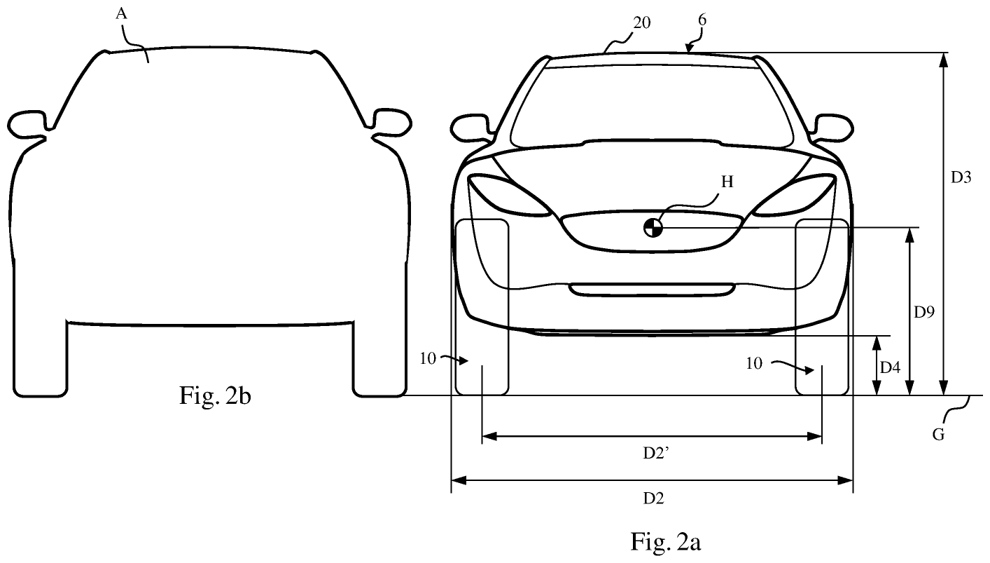

Referring firstly to FIGS. 1 and 2, a vehicle 2 is shown that is configured for implementation as an energy efficient electric vehicle. In this context, the vehicle may be fully electric, as would be powered by one or a combination of a battery pack, a hydrogen fuel cell and photovoltaic cells, or it may also be a hybrid electric vehicle that combines an electric prime mover with an internal combustion engine, such as a gasoline, diesel or gas engine, for example. Since this discussion is concerned with the overall configuration of the exterior attributes of the vehicle 2, it will be appreciated that the precise form of motive power sources used in the vehicle are not the focus of the discussion and so are not shown in the drawings. However, as an example, the vehicle 2 may be provided with a battery pack 4 positioned generally in a body 6 of the vehicle, and one or more electric motors. Here, one or more electric motors 8 are provided to drive front wheels 10 of the vehicle, and one or more electric motors 12 are provided to drive the rear wheels 14 of the vehicle 2. Here, each of the wheels 10, 14 comprises a tire 11 mounted on a wheel rim 13.

In overview, the vehicle body 6 comprises a vehicle roof 20 which defines the upper surface of the vehicle 2 extending rearwards from a windscreen 22 of the vehicle towards the rear of the vehicle, a front section 26, a rear section 28, and a vehicle underside 30.

A significant advantage of the vehicle 2 is that it is configured to achieve a long driving range and to be comfortable for its occupants whilst minimising the aerodynamic compromises that are usually made whilst meeting this design objective. This is achieved generally by a combination of the vehicle length, its frontal area, and the ground clearance of the vehicle. These vehicle attributes will now be discussed in more detail.

Notably, the vehicle length in the illustrated embodiment is between 4700 mm and 5000 mm, and currently preferred is about 4900 mm. In some embodiments the vehicle length may be up to 5100 mm or more, and may be as low as 4550 mm. The length is indicated by dimension D1 on FIG. 1. FIG. 1 also shows many other vehicle dimensions and these will be discussed below in more detail. As will be apparent, the considerable length of the vehicle ensures that plentiful cabin space is provided in the vehicle, thereby benefiting passenger comfort, despite the constraints imposed by a relatively limited frontal area which is desirable from a drag perspective.

The skilled person will appreciate that the main contributors to frontal area are the vehicle height, the vehicle width and the ground clearance. These are best appreciated from FIG. 2, on which these dimensions are labelled. Turning to FIG. 2, the vehicle has an overall width (indicated as D2) between the vehicle flanks of between 1925 mm and 1975 mm Currently it is envisaged that the width will be about 1950 mm, although any width between the previously mentioned boundaries is considered acceptable. The track width of the vehicle is also shown on FIG. 2, as indicated by D2′, and is greater than 1600 mm. In the illustrated embodiment the track width is 1685 mm.

The height of the vehicle 2, as is indicated as D3 on FIG. 2, may be between 1600 mm and 1800 mm, for example between 1650 mm and 1700 mm, or even between 1650 and 1680. The height is currently envisaged to be about 1660 mm Note that the height dimension is measured from a theoretical ground plane G on which the vehicle rests with a nominal load and extends to the horizontal projection of the uppermost vertical point of the vehicle roof.

The ground clearance of the vehicle 2 is indicated on FIG. 2 as D4 and is the distance between the ground plane G and the vehicle underside 30. As can be seen in FIG. 2, the vehicle underside 30 is relatively flat without any significant protuberances and as such may be defined by an aerodynamic undertray to improve the flow of air under the vehicle when moving. The ground clearance D4 is comparatively large in this embodiment, being at least a nominal distance of 260 mm in some embodiments. It is currently envisaged that the maximum nominal ground clearance will be about 310 mm by way of example, and currently preferred is 300 mm. Note that the vehicle may be supported on adaptable suspension which provides the facility to vary the ground clearance of the vehicle, for example based on driving modes. During highway driving for example, the suspension may be selectively adaptable to lower the ground clearance of the vehicle, whereas during urban driving or in off-road conditions the suspension may adapt to raise the ground clearance of the vehicle. In some embodiments, the suspension may be configured to be able to adjust the ground clearance of the vehicle within the range of about 200 mm to 350 mm. As will become apparent, the aforementioned ground clearance is relatively high in comparison to the position in which the passengers sit in the vehicle. The high ground clearance is in part enabled by the wheels which have a surprisingly large outer diameter compared to the other dimensions of the vehicle. This aspect will be discussed later. However, it is notable that the height of the vehicle is relatively low compared to its length, for example between about 30% and 37% of the overall length of the vehicle. Also, the vertical distance between the underside of the vehicle and the vehicle roof height (D3-D4), as compared to the length of the vehicle, is between about 25% and 30%.

The combination of vehicle height, width, ground clearance and the overall vehicle profile as discussed above provides a frontal area of between about 2.5 m2 (square metres) and about 2.7 m2 which is comparatively small for such a large vehicle and therefore is a strong factor in promoting good aerodynamic efficiency of the vehicle, which is a function of frontal area and the drag coefficient (Cd) of the vehicle, as would be understood by the skilled person. To avoid doubt, the term ‘frontal area’ is being used here to have the accepted industry meaning as being the area of the vehicle as seen from the front of it, for example, the area of an image of the vehicle projected on a vertical surface at the front of the vehicle by a light source behind the vehicle. A depiction of the frontal area of the vehicle is shown in FIG. 2b labelled as ‘A’.

To offset the relatively small frontal area, the length of the vehicle provides a large cabin space for accommodating passengers and luggage. The available cabin space is maximised by configuring the vehicle 2 with a relatively long wheelbase, being is the horizontal distance between the front and rear wheel axes as indicated by D5 in FIG. 1. The relatively long wheelbase also benefits the comfortable driving dynamics of the vehicle. In some embodiments the wheelbase may be between 2950 mm and 3350 mm, preferably between about 3000 mm and 3350 mm, more preferably between 3200 mm and 3350 mm. It is envisaged that the wheelbase is about 3335 mm. It should be appreciated that the wheelbase is relatively long in comparison to conventional passenger vehicles and this contributes to good stability over undulating road surfaces.

Taken in conjunction with the length of the vehicle, the relatively long wheelbase D5 positions the wheels 10, 14 towards the four corners of the vehicle 2 which means that the vehicle body 6 can be configured to provide a large area between the front and rear wheels as cabin space or to house equipment. FIG. 1 shows an example of this, in which the battery pack 4 is positioned beneath the cabin of the vehicle between the front and rear wheels 10, 14. The relatively long wheelbase means that the floor area for the battery pack 4 is maximised and so, for a given battery volume requirement, the battery pack 4 can be made relatively long and shallow to make effective use of the floor area of the vehicle. This also provides useful real estate to install a larger battery pack so as to take advantage of the increased energy storage and discharge characteristics that a larger battery pack allows, and contributes to lowering the centre of mass of the vehicle.

The length of the wheelbase D5 compared to the overall vehicle length D1 results in the vehicle 2 having short front and rear overhangs. In FIG. 1, the front overhang is defined by the front section 26 of the vehicle and is indicated by reference D6, being the horizontal distance between the front wheel axis X1 and the front most edge, or the leading edge 40 of the vehicle. Similarly, the rear overhang is defined by the rear section 28 of the vehicle 2, and is indicated by reference D7, being the horizontal distance between the rear wheel axis X2 and the rear most edge or trailing edge 42 of the vehicle.

In some embodiments, the front overhang dimension may be about 820 mm. However, it is envisaged that the front overhang dimension may be in the range of between about 750 mm and 850 mm. The rear overhang dimension is similarly short and in the illustrated embodiment may be about 900 mm, although it is envisaged that a rear overhang in the range of 850 mm and 950 mm will be acceptable. The short overhang dimensions D6, D7 of the vehicle 2 mean that the length of the wheelbase is maximised given the length of the vehicle, and they also contribute to providing the vehicle with desirable handling characteristics due to the reduction of mass located beyond the wheelbase of the vehicle. Furthermore, the short overhangs benefit low speed maneuvering since the driver of the vehicle can readily estimate the extremities of the vehicle. Linked to the short front and rear overhangs are front and rear breakout angles of the vehicle, A1 and A2. These may also be known as the approach and departure angles, respectively. Beneficially, the front and rear breakout angles are configured to be relatively large due to the short respective overhangs and the relatively high ground clearance of the vehicle as will be discussed in further detail later. In the illustrated embodiment, the front breakout angle A1 and the rear breakout angle A2 are approximately 30 degrees but may be between 25-35 degrees. The relatively large breakout angles benefit the ability of the vehicle to deal with steep terrain and obstacles.

As has been mentioned above, the overall configuration of the vehicle provides a relatively small frontal area for such a large vehicle, but the length of the vehicle maintains a useful internal cabin volume which can accommodate passengers, luggage and other equipment. Currently it is envisaged that the vehicle would be equipped with up to seven seating locations, for example arranged in three seat rows, as is the case with the illustrated embodiment. Conventionally, a vehicle with such a passenger capacity would have a much larger frontal area, but the vehicle of the disclosure is configured with a small frontal area which improves its drag coefficient whilst retaining a cabin capacity for up to seven passengers.

Further improvements in aerodynamic efficiency are achieved by combining the comparatively small frontal area of the vehicle with a slippery front profile, as is apparent from FIG. 1, and as will now be discussed in more detail.

Referring then to FIG. 1, it has already been mentioned that the vehicle includes a relatively short front overhang which is between 750 mm to 850 mm, and nominally 820 mm in this embodiment. However, what is apparent in FIG. 1 is that that the bonnet or hood cover 44 is also compact, and extends a short way rearward of the front wheel axis 8 before the windscreen 22 begins. Furthermore, the windscreen has a swept back appearance and as such has a low angle of inclination relative to the horizontal plane. In some embodiments, the horizontal distance between the front wheel axis and a rear or trailing edge 46 of the bonnet cover is approximately 55 mm. However, it is envisaged that this dimension may be between 45 mm to 65 mm Note that the distance is measured along the approximate centreline of the vehicle 2 and is indicated on FIG. 1 as D8. So, this means that the rear edge of the bonnet cover 44 is located at a point approximately 875 mm from the leading edge 40 of the vehicle, in the illustrated embodiment, although a dimension range of between 825 mm and 925 mm would be acceptable. The compact bonnet is combined with a shallow screen angle of between 60 degrees and 65 degrees, which is measured from the vertical plane to a tangent of a lower portion of the windscreen. More specifically, the screen angle may be between 62 and 65 degrees from the vertical plane. Expressed in another way, the screen angle may be between 25 and 30 degrees, preferably 28 degrees, when referenced to an imaginary horizontal plane. From there the windscreen gradually curves along an increasingly shallow trajectory until it reaches the forward roof line of the vehicle 2. The screen angle is illustrated on FIG. 1 at A3. Note that it is at the trailing edge 46 of the bonnet cover 44 where the windscreen rises upwards and intersects the plane of the bonnet cover 44.

It is notable, too, that from a side profile the line of the windscreen merges smoothly with the roofline of the vehicle 2 and extends rearwards at a shallow reverse angle of inclination and terminates at the rear section 28 of the vehicle at a sharp rear edge 50, which is a benefit for aerodynamic efficiency as that profile encourages airflow separation at the rear of the vehicle thereby reducing drag. This is complimented by a relatively high waistline 51 that inclines at a shallow angle from the A-pillar of the vehicle towards the D-pillar over the tops of the door panels.

Appreciating the side profile of the vehicle in FIG. 1, the reader will notice the rather raked appearance provided by the short front section 26, the reclined windscreen 22, and the relatively low roof line which slopes downward and rearward towards the back of the vehicle. These factors contribute to good aerodynamic characteristics for the vehicle, despite its size and passenger capacity, which may be up to seven people, at least. The position adopted by the passengers is configured to complement the relatively low-slung configuration of the vehicle, and as an example of this a row of front seats 52 is depicted in FIG. 1.

Turning now to the front seats 52, it should be noted that the front seats 52 of the vehicle are situated in a relatively low position with respect to the floor of the vehicle which provides a useful amount of headroom for the driver. The front seats 52 are also represented by an H-point, which is labelled as H on FIG. 1. As the skilled reader will appreciate, the H-point is the theoretical position of an occupant's hip when they are seated in the vehicle, and represents the pivot point between the upper and lower portions of the body. In some embodiments, and as has been mentioned, the H-point is in a relatively low location in the vehicle. More specifically, in some embodiments, the H-point is at a height of about 750 mm above the ground plane, as represented by dimension D9. More broadly, it is envisaged that an H-point height may have a nominal value of between 740 mm and 760 mm. However, this range may also be wider, particularly in embodiments equipped with adjustable suspension in which the range may be between 710 mm and 790 mm.

Significantly, the H-point in some embodiments is located at a vertical distance of about 450 mm above the vehicle underside 30 (marked as D9′ on FIG. 1). Since the battery pack 4 is located beneath the vehicle cabin, between the vehicle underside 30 and the cabin floor, it will be appreciated that the passenger in the seat 52 sits low down in the vehicle which is atypical for such a large vehicle. This seating position may also provide the driver with a sensation that they are sitting low down or ‘in’ the vehicle which benefits drivability. Such a position is similar to the height at which a person would sit within a saloon or sedan like vehicle, having a relatively low ground clearance, so is not expected on a vehicle exemplified in the illustrated embodiment which has a much higher ground clearance, more typical of an SUV-style vehicle. Although not shown in FIG. 1, the H-point is preferably located between 260 mm and 300 mm above the cabin floor of the vehicle.

The low H-point position avoids compromising the low roof height which would otherwise increase the vehicle frontal area thereby impacting on aerodynamic efficiency. As illustrated, the front row of seats are in a relatively inclined orientation whilst the long wheelbase of the vehicle 2 also allows the seating position of the front row to be located close to the mid-point of the vehicle, such factors being a benefit for passenger comfort since the front row passengers are more isolated from wheel vibrations. Importantly, this may be achieved without compromising on the space for the passengers in a second row of seats 53 since the long wheelbase enables the second row seating position to have premium levels of legroom. A third, optional, row of seats 54 is also provided. For instance it is envisaged that the second row 53 will be configured with between 810 mm to around 1120 mm between the H-point of the second row and the H-point of the first row 52, as indicated by the arrow labelled 55.

As an example, it is currently envisaged that the H-point may be selected to be at a horizontal position, relative to the leading edge of the windscreen and taken along the centreline of the vehicle, of about 1480 mm Note that this dimension value is a specific example but that others would also be possible, and it is currently envisaged that H-point positions between 1400 mm and 1500 mm would be acceptable. This dimension is indicated on FIG. 1 as D10. It follows from the above dimensions that the horizontal distance between the H-point and the front wheel axis A1 may be between 1430 mm and 1550 mm, and in the illustrated embodiment is 1516 mm.

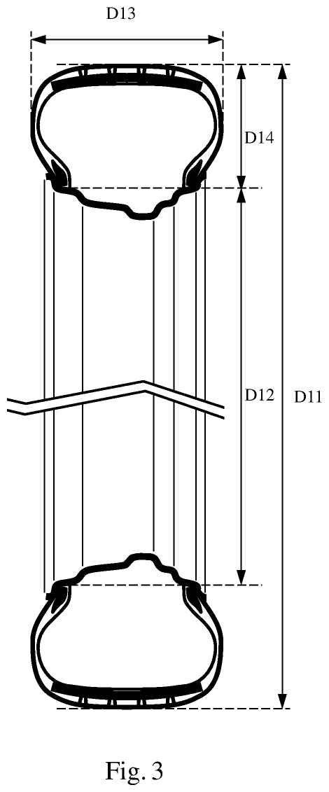

Focusing now more specifically on FIGS. 2 and 3, a further striking aspect of the vehicle 2 is the configuration of the front and rear wheels 10, 14 in the context of the overall shape and size of the vehicle. Conventionally, in the passenger vehicle context the dimension of wheels is measured in inches and it is typical for relatively large passenger vehicles to be provided with wheels whose rims are between 15 and 17 inches in diameter. Larger diameter wheel rims used to be the preserve of the aftermarket modification sector, although it is becoming more normal now to equip vehicles off the production line with 18 or 19 inch rims, and some large sports utility vehicles (SUV) may be equipped with 20 or even 21 inch rims.

When viewing FIGS. 2 and 3, however, it is noticeable that the wheels 10, 14 have a large diameter, such that they are approximately 50% of the overall vehicle height. More specifically, the outer diameter of the wheels may be 845 mm in some embodiments, although a diameter of between 800 mm and 850 mm is also acceptable. This dimension is indicated as D11 on FIG. 3.

Whereas the overall diameter of the wheel 10 is nominally 845 mm, in this embodiment, the diameter of the wheel rim 13 in this embodiment is 24 inches (approx. 610 mm), although it is envisaged that a rim diameter of 23 inches (approx. 584 mm) would also be acceptable. This dimension is indicated as D12 on FIG. 3. It is envisaged that the wheels will be fabricated as once-piece cast or forged alloy wheel structure. However, two-piece or three-piece wheel structures are also acceptable. Although the diameter of the wheels is relatively large, it is also significant that the wheels are relatively narrow, and this can be appreciated by FIGS. 2 and 3 particularly. Here, the width of the tires 11 is between 235 mm and 255 mm. This dimension is indicated as D13 on FIG. 3. Also notable is the relatively large sidewall height or depth of the tire compared to its section width, D13. Typically, larger wheels fitted to vehicles will tend to be fitted with tires with a very low side profile. This is because lower profile tires tend to exhibit improved cornering stiffness and mitigate the overall wheel diameter that is caused by increasing the rim diameter. In general, larger wheel sizes are generally thought to be undesirable in contemporary vehicles since they impact negatively on turning circle, wheel arch volume, and ride quality. However, in the vehicle of the disclosure, the tire depth is envisaged to be approximately 50% of the section width of the tire, for example between about 45% and 55%. In the illustrated embodiment, having a nominal wheel diameter or 845 mm, and a rim diameter of 24 inches, the tire depth is approximately 117 mm, as is indicated as D14 on FIG. 3. The relatively deep section tire is a benefit since it absorbs higher frequency vibrations and increases the overall wheel diameter which benefits rolling resistance. By way of example, it is envisaged that a tire having an outer diameter, section width and side wall depth may achieve a rolling resistance of between 4.5 kg/t and 6 kg/t, and it is believed that these values are significantly lower than rolling resistance of tires used on tires having a smaller outer diameter (for example 18 or 20 inch tires) and a wider tire section. The rolling resistance as expressed here is the rolling resistance coefficient, or C_{π}, in units of kilograms per tonne, as would be understood by the skilled person. Such a wheel and tire combination is not seen on contemporary vehicles fitted with radial tubeless tires, or even airless tires and, moreover, not on mass-produced vehicles that are manufactured in numbers in the order of tens of thousands of vehicles per year, at least.

The relatively tall and narrow wheels in the illustrated embodiment of the disclosure are beneficial in several further respects, as will now be explained.

Firstly, they are considered to contribute to the reduced frontal area of the vehicle, thereby reducing aerodynamic drag. Therefore, the use of large diameter wheels has a synergistic benefit since it provides advantages both for rolling resistance and the reduction in aerodynamic drag. At highway speeds, aerodynamic drag and rolling resistance are the two major contributors to the energy consumption of the vehicle. So, the vehicle of the disclosure achieves a significant improvement in this area which benefits its real-world range.

Significantly, the large diameter wheels are instrumental in the relative high ground clearance of the vehicle 2. As mentioned above, the ground clearance of the vehicle in the illustrated embodiment is about 300 mm which is comparatively high as compared to saloon or sedan like vehicles, although the front row of passengers are supported within the vehicle in a more low-down, sedan-like seating position. This high ground clearance is made possible at least in part due to the large diameter wheels. The advantageous ground clearance combines with the long wheelbase of the vehicle to avoid compromising the breakover angle. As shown in FIG. 1, the breakover angle ‘A4’ in the illustrated embodiment is approximately 21 degrees, and may be between 20 and 22 degrees.

Furthermore, without wishing to be bound by theory it is believed that the larger diameter and relatively narrow wheels will reduce the tendency to aquaplane in wet road conditions and will improve traction in snow. It is also envisaged that the large diameter wheels will transmit less road noise into the cabin of the vehicle and will benefit the stability of the vehicle on the move since the large diameter wheels are less affected by rough road surfaces and potholes.

Another benefit is that the larger rim diameter provides the opportunity to equip the vehicle with larger diameter brake discs. Larger diameter brake discs are believed to be beneficial since they allow a clamping load to be applied at a larger radius. So, the same brake torque can be generated by using a lower clamping load, which provides the opportunity to use more compact and lightweight brake pistons and calipers, thereby reducing unsprung mass. It is also believed to be better for brake cooling since the larger discs will expose a greater surface area to air flow around the wheel.

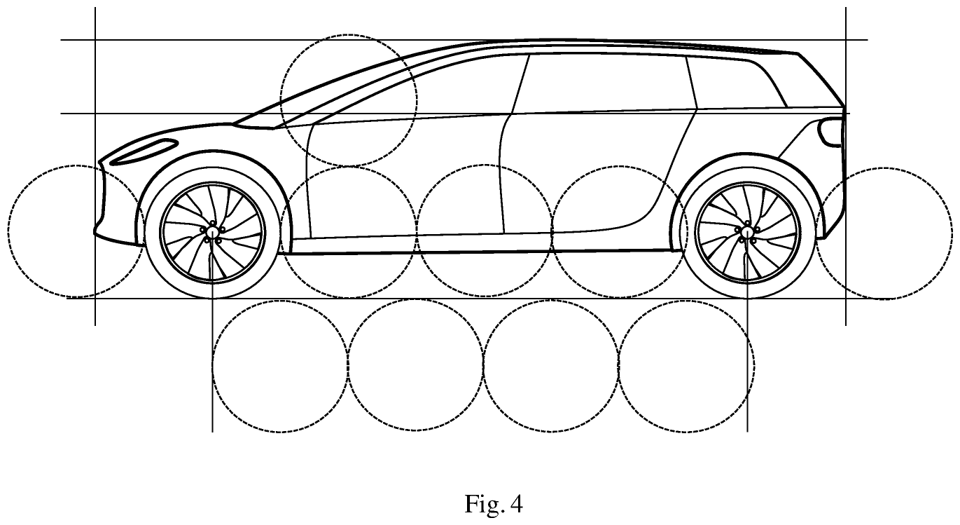

Finally, reference will be made to FIG. 4. Here, the vehicle 2 depicted is the same as FIG. 1, but the body proportions of the vehicle are illustrated with reference to wheel diameters of the vehicle. Accordingly, a dimension of one wheel diameter will be expressed as ‘1D’. Multiples and fractions of such diameters will be expressed with the same convention.

In terms of wheelbase, the distance between the front and rear wheels is approximately 3D, although the distance is slightly less than 3D in the illustrated embodiment. Also, the wheelbase dimension taken between the axle centres is approximately 4D. The overall length of the vehicle is approximately 6D. The front overhang is less than 0.5D, and approximately 0.3D. The rear overhang is less than 0.3D. The height of the vehicle waistline is approximately 1.5D, whereas the roofline height is approximately 2D. Notably the ground clearance is approximately 0.3D.

The skilled person would appreciate that the embodiments described herein may be modified without departing from the inventive concept as defined by the claims.

For example, the illustrated embodiment is equipped with wing mirrors. However, embodiments are also envisaged in which the wing mirrors are omitted and a rear view from the vehicle is provided by a camera system instead. This benefits aerodynamic efficiency since wing mirrors present an obstruction to airflow past the vehicle and therefore are a source of drag. Omitting the wing mirrors thus provides the vehicle with a cleaner profile.

1. An electric vehicle having a vehicle height of between 1600 mm and 1800 mm, a ground clearance of at least 260 mm, and a windscreen inclined at an angle of between 25 and 30 degrees relative to the horizontal plane, wherein the horizontal distance between a leading edge of the vehicle and a leading edge of the windscreen is less than 870 mm.

2. The electric vehicle of claim 1, wherein the vehicle comprises a driver seat having a seat height of between 260 mm and 300 mm.

3. The electric vehicle of claim 1, wherein the vertical distance between the driver H-point and the ground is at least 740 mm.

4. The electric vehicle of claim 1, wherein the vehicle has a front overhang less than 850 mm.

5. The electric vehicle of claim 1, wherein the vehicle has a wheelbase of between 3200 mm and 3350 mm.

6. The electric vehicle of claim 5, wherein the vehicle has a vehicle length of between 4700 mm and 5000 mm.

7. The electric vehicle of claim 5, wherein the vehicle has breakover angle of at least 20 degrees.

8. The electric vehicle of claim 1, wherein the vehicle comprises a passenger cabin and a battery pack positioned beneath the passenger cabin.

9. The electric vehicle of claim 1, wherein the vehicle has a front overhang less than 850 mm and a rear overhang less than 950 mm.

10. The electric vehicle of claim 1, wherein the vehicle has an approach angle and a departure angle of at least 25 degrees.

11. The electric vehicle of claim 1, wherein the vehicle has a frontal area less than 2.7 square meters.

12. The electric vehicle of claim 1, wherein the vertical distance between the roof of the vehicle and the underside of the vehicle is between 1340 mm and 1465 mm.

13. The electric vehicle of claim 1, wherein the vehicle comprises wheels having an outer diameter of between 45% and 55% of the vehicle height.

14. The electric vehicle of claim 13, wherein the wheels have a section width of between 27% and 32% of the outer diameter of the wheels.

15. The electric vehicle of claim 13, wherein the wheels have an outer diameter of between 800 mm and 850 mm, and a section width of between 235 mm and 255 mm.

16. The electric vehicle of claim 13, wherein the wheels have a section height of between 80 mm and 135 mm.

17. The electric vehicle of claim 13, wherein the vehicle has a vehicle width less than 1975 mm.
